(19) United States
(12) Patent Application Publication
(10) Pub. No.: US 2005/0098181 A1
(43) Pub. Date: May 12, 2005

(54) Gas inlet and diffuser assembly having a bendable inlet tube with memory for a neonatal hood

(76) Inventor: Wallace Edward Trammell, Provo, UT (US)

Correspondence Address: Angus C. Fox, III, 4093 N. Imperial Way, Provo, UT, 84604-5386, US

(21) Appl. No.: 10/962,966

(22) Filed: Oct. 12, 2004

Related U.S. Application Data
(60) Provisional application No. 60/510,551, filed on Oct. 10, 2003.

(51) Int. Cl. A61G 10/00

(52) U.S. Cl. 128/205.26

(57) ABSTRACT

An improved gas inlet and diffuser assembly for a neonatal hood functions as a hose coupler, a bendable gas inlet, and a gas diffuser. The assembly includes a flexible inlet tube, a portion of which is equipped with a plurality of annular bellows. The bellows, which are much like those of the bendable portion of a bendable drinking straw, are designed to assume and retain an angular bend over about a 180-degree sweep. Thus the inlet tube may be adjusted to compensate for any bending or lifting force applied by an incoming oxygen supply tube by bending the inlet tube so that it meets straight on with the incoming oxygen tube, thereby permitting the entire bottom edge of the neonatal hood, in which the insert is installed, to contact the pad on which the infant is placed. The insert is preferably manufactured from a flexible polymeric plastic material, such as polyethylene or polypropylene.

This application has a priority date based on Provisional Patent Application No. 60/510,551, which has a filing date of Oct. 10, 2003.

### BACKGROUND OF THE INVENTION

1. Field of the Invention

This invention relates generally to gas inlets and diffuser assemblies for neonatal hoods. It also relates to tubing incorporating a bellows section that is flexible and retains a set shape.

2. Description of the Prior Art

Clear plastic bubble hoods have been developed to cover the heads of premature infants. A moist, oxygen-rich atmosphere is piped to the hood for the infant to breathe. U.S. Design Pat. No. 273,612 shows such a hood. The hoods are typically fabricated from a tough, resilient polymeric material, such as polycarbonate. The insert opposite the neck and shoulder opening is a gas inlet and diffuser assembly for the moist, oxygen-rich atmosphere that is provided to the infant. A problem associated with the provision of piped-in gases to the hood is that the tubing used to convey the gases, though flexible, often exerts, through the inlet and diffuser assembly, a twisting or lifting torque on the hood so that the bottom edge of the hood refuses to make contact along its entire length with the pad on which the infant is placed.

What is needed is an improved gas inlet and diffuser assembly for a neonatal hood which is adjustable to eliminate any twisting or lifting torque exerted by an oxygen hose that is coupled thereto.

### SUMMARY OF THE INVENTION

The present invention provides an improved gas inlet and diffuser assembly for a neonatal hood which functions as a hose coupler, a gas inlet, and a gas diffuser. The assembly includes a flexible inlet tube, a portion of which is equipped with a plurality of annular bellows. The bellows, which are much like those of the bendable portion of a bendable drinking straw, are designed to assume and retain an angular bend over about a 180-degree sweep. Thus the inlet tube may be adjusted to compensate for any bending or lifting force applied by an incoming oxygen supply tube by bending the inlet tube so that it meets straight on with the incoming oxygen tube, thereby permitting the entire bottom edge of the neonatal hood, in which the insert is installed, to contact the pad on which the infant is placed. The insert is preferably manufactured from a flexible polymeric plastic material, such as polyethylene or polypropylene. Also for a preferred embodiment of the invention, the inlet tube is threadably attached to a deflector/diffuser. In order to secure the insert to the neonatal hood, an aperture is provided in the transparent bubble of the neonatal hood, and the deflector/diffuser and the inlet tube are assembled through the aperture, thereby sandwiching the transparent bubble between the deflector/diffuser and inlet tube. Alternatively, the deflector/diffuser may be chemically welded or adhesively bonded to the inlet tube portion.

### BRIEF DESCRIPTION OF THE DRAWINGS

FIG. 1 is an isometric view of a neonatal hood in which is installed the improved gas inlet and diffuser assembly of the present invention;

FIG. 2 is a side elevational view of a neonatal hood, in which is installed the improved gas inlet and diffuser assembly.

FIG. 3 is a top plan view of the improved assembled gas inlet and diffuser assembly for a neonatal hood;

FIG. 4 is a top plan view of the improved gas inlet and diffuser assembly, which has been disassembled showing a screw-together first embodiment of the inlet tube and gas diffuser portions;

FIG. 5 is a top plan view of the improved gas inlet and diffuser assembly, which has been disassembled showing an adhesively-bondable-together second embodiment of the inlet tube and gas diffuser portions;

FIG. 6 is a top plan view of the improved gas inlet and diffuser assembly, which has been disassembled showing a snap-together third embodiment of the inlet tube and gas diffuser portions;

FIG. 7 is a top plan view of the inlet tube portion of the first, second or third embodiments, showing it bent in and maintaining about a 45-degree angle; and

FIG. 8 is a cross-sectional vew of both the inlet tube and gas diffuser portions.

### PREFERRED EMBODIMENT OF THE INVENTION

The invention will now be described with reference to the attached drawing figures.

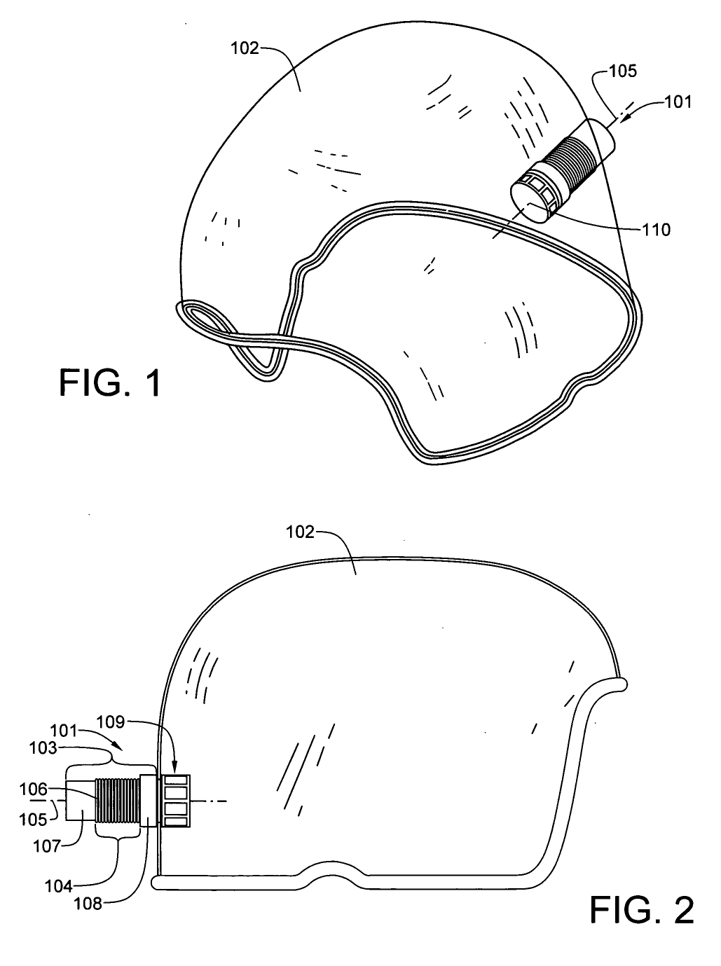

Referring now to FIGS. 1 and 2, the improved gas inlet and diffuser assembly 101 is shown installed in a neonatal hood 102, and includes an inlet tube 103 and a gas deflector/diffuser 104. The inlet tube 103 has a bendable bellows 104 that is similar in structure to the bendable portion of a flexible straw. That is, the bellows are collapsible, and when bent, the bellows assume maximum expansion along the outside radius of the bend and minimum expansion along the inside radius of the bend. The bellows portion 104 may be bent at least 90 degrees in any direction away from the central axis 105. As the bend is made, individual annular components 106 of the bendable bellows portion 104 snap open or closed, thereby providing “memory” to the curve or bend so that the bend is retained. The inlet tube 103 has a hose attachment end 107, to which an oxygen supply hose may be connected. The inlet tube 103 also has a hood attachment end 108, which couples to a deflector/diffuser 109. The deflector/diffuser 109 installs within the neonatal hood 102, is inserted through an aperture in the wall of the neonatal hood 102 and couples with the hood attachment end 108 of the inlet tube 103. The deflector/diffuser 109 has an end plate 110, which prevents the flow of oxygen from being directed against the infant's head. Instead, the gases expelled from the deflector/diffuser 109 are deflected radially and at about a 90-degree angle from the central axis 105.

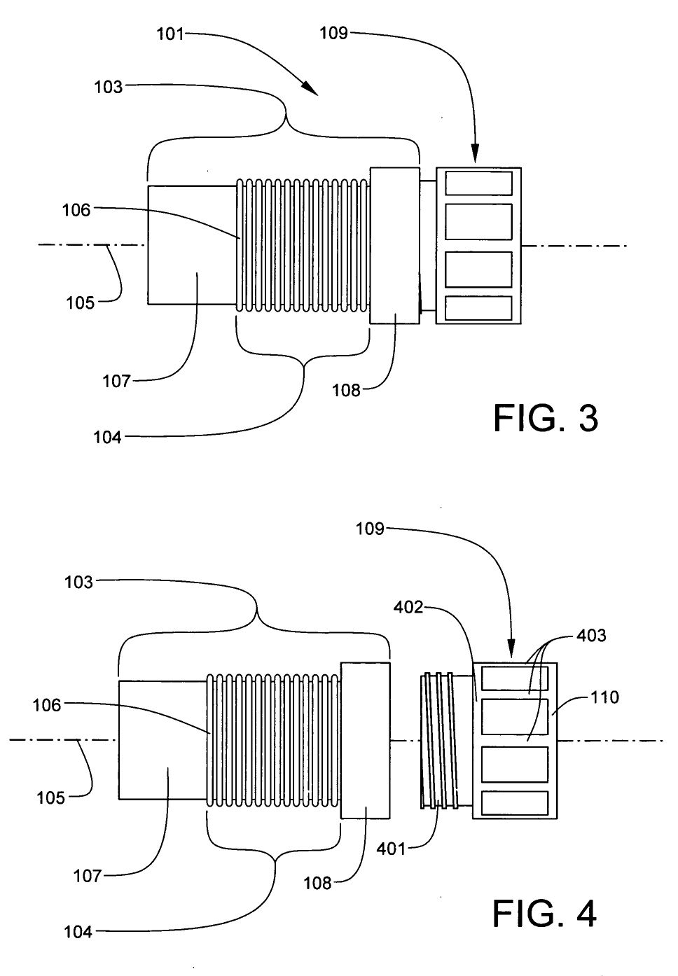

Referring now to FIG. 3, the improved gas inlet and diffuser assembly 101 is shown separately from the neonatal hood 102. The structure of the bellows portion 104 can be clearly seen in this view.

Referring now to FIG. 4, a first embodiment of the improved gas inlet and diffuser assembly 101 is shown disassembled. The deflector/diffuser 108 is fitted with a male threaded extension 401, while the hood attachment end 108 of the inlet tube 103 is equipped with internal threads (not shown) which mate with those of the male threaded extension 401. This arrangement may, of course, be reversed, with the deflector/diffuser 108 being fitted with a female threaded receptacle and the inlet tube 103 being fitted with a male threaded extension. However, the preferred embodiment is shown because more clearance is provided between the deflector/diffuser 103 and the head of the infant. It will be noted that the deflector/diffuser 109 includes an outlet portion 402 that is attached to the end plate 110 multiple standoffs 403.

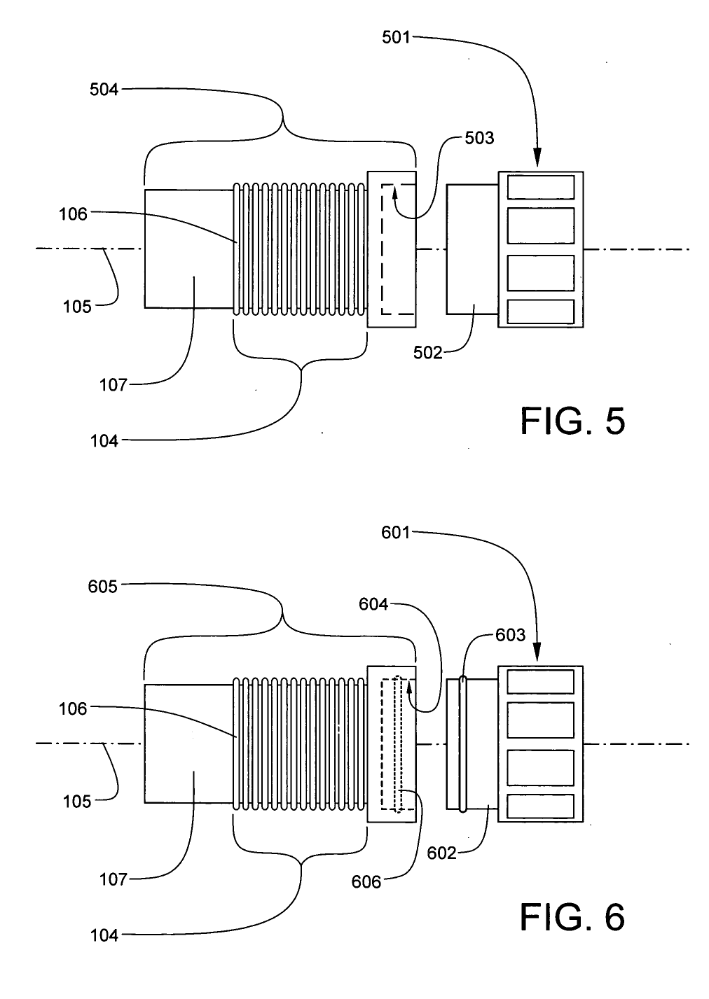

Referring now to FIG. 5, a second embodiment of the invention is shown, in which the gas diffuser portion 501 includes a male member 502 which slides into a female socket 503 of the gas inlet portion 504. The two portions 501 and 504 may be adhesively bonded together.

Referring now to FIG. 6, a third embodiment of the invention is shown, in which the gas diffuser portion 601 includes a male member 602 having a circumferential projection 603, which slides into a female socket 604 of the gas inlet portion 605 and locks into a circumferential groove 606.

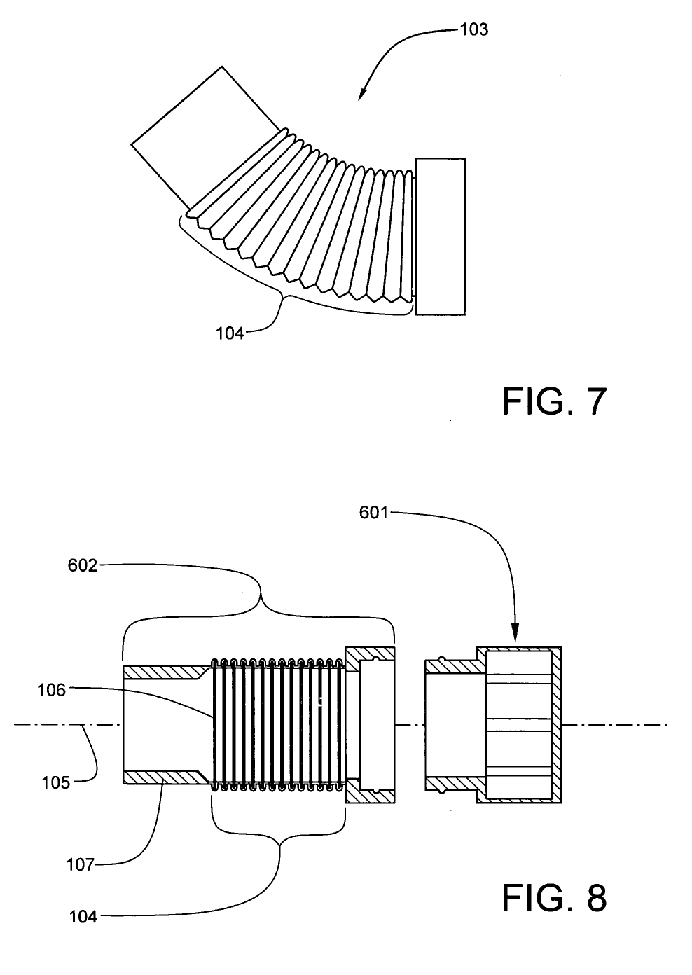

Referring now to FIG. 7, the gas diffuser portion 103 is shown with a sustainable bend of about 45 degrees. The bellows portion 104 provides the flexible bend and maintains the angle until readjusted.

Referring now to FIG. 8, a third embodiment of the invention is shown in cross-sectional format.

The insert is preferably manufactured from a flexible polymeric plastic material, such as polyethylene or polypropylene.

Although only several embodiments of the protective coating are disclosed herein, it will be obvious to those having ordinary skill in the art that changes and modifications may be made thereto without departing from the scope and the spirit of the invention.

1. A gas inlet assembly for installing within a circular aperture in a neonatal hood, said gas inlet assembly comprising:
an inlet tube having a flexible portion equipped with a plurality of annular bellows, said bellows-equipped portion capable of assuming and retaining an angular bend, and interconnecting a hose attachment end and a hood attachment end; and
a deflector/diffuser installable within the neonatal hood and connectable to hood attachment end through said circular aperture.

2. The gas inlet assembly of claim 1, wherein said bellows-equipped portion is capable of assuming and retaining an angular bend over about a 180-degree sweep.

3. The gas inlet assembly of claim 1, wherein said hood attachment end and said deflector/diffuser interconnect via a threaded connection.

4. The gas inlet assembly of claim 1, wherein said hood attachment end and said deflector/diffuser interconnect via a snap-together connection.

5. The gas inlet assembly of claim 1, wherein said hood attachment end and said deflector/diffuser interconnect via a chemically bonded connection.

6. The gas inlet assembly of claim 1, wherein said deflector/diffuser includes an outlet portion and an end plate which is attached to said outlet portion via a plurality of standoffs, said end plate a radial deflection of gases which enter the deflector/diffuser in an axial direction from the inlet tube.

7. The gas inlet assembly of claim 6, wherein at least a portion thereof is fabricated from a flexible polymeric plastic material.

8. The gas inlet assembly of claim 7, wherein said polymeric plastic material is selected from the group consisting of polyethylene and polypropylene.

9. A gas inlet assembly, a first end of which is connectable to a gas supply hose, and a second end of which is attachable to an article to which gas is supplied, said gas inlet assembly comprising a flexible inlet tube portion equipped with a plurality of collapsible annular bellows, said bellows-equipped portion capable of assuming and retaining an angular bend through maximum expansion of the annular bellows along an outside radius of the angular bend and minimum expansion of the annular bellows along an inside radius of the angular bend.

10. The gas inlet assembly of claim 9, which further comprises a deflector/diffuser connectable to said second end, and installable within a circular aperture in a laminar region of said article.

11. The gas inlet assembly of claim 9, wherein said bellows-equipped portion is capable of assuming and retaining an angular bend over about a 180-degree sweep.

12. The gas inlet assembly of claim 9, wherein said second end and said deflector/diffuser interconnect via a threaded connection.

13. The gas inlet assembly of claim 9, wherein said second end and said deflector/diffuser interconnect via a snap-together connection.

14. The gas inlet assembly of claim 9, wherein said second end and said deflector/diffuser interconnect via a chemically bonded connection.

15. The gas inlet assembly of claim 9, wherein said deflector/diffuser includes an outlet portion and an end plate which is attached to said outlet portion via a plurality of standoffs, said end plate a radial deflection of gases which enter the deflector/diffuser in an axial direction from the inlet tube.

16. The gas inlet assembly of claim 15, wherein at least said bellows-equipped portion is fabricated from a flexible polymeric plastic material.

17. The gas inlet assembly of claim 16, wherein said polymeric plastic material is selected from the group consisting of polyethylene and polypropylene

18. A gas inlet assembly, a first end of which is connectable to a gas supply hose, and a second end of which is attachable to a neonatal hood, said gas inlet assembly comprising a flexible inlet tube portion equipped with a plurality of collapsible annular bellows, said bellows-equipped portion capable of assuming and retaining an angular bend through maximum expansion of the annular bellows along an outside radius of the angular bend and minimum expansion of the annular bellows along an inside radius of the angular bend.

19. The gas inlet assembly of claim 18, which further comprises a deflector/diffuser installable from within the neonatal hood through a circular aperture in a laminar portion thereof, and connectable to said second end outside the neonatal hood.

20. The gas inlet assembly of claim 18, wherein said bellows-equipped portion is capable of assuming and retaining an angular bend over about a 180-degree sweep.
